(19) United States
(12) Patent Application Publication
(10) Pub. No.: US 2020/0005040 A1
(43) Pub. Date: Jan. 2, 2020

(54) AUGMENTED REALITY BASED ENHANCED TRACKING

(71) Applicant: Xinova, LLC, Seattle, WA (US)

(72) Inventors: Shmuel UR, Shorashim (IL); Or ZILBERMAN, Haifa (IL); Vlad Grigore DABIJA, Mountain View, CA (US)

(73) Assignee: Xinova, LLC, Seattle, WA (US)

(21) Appl. No.: 16/488,983

(22) PCT Filed: Jan. 29, 2018
(86) PCT No.: PCT/US2018/015749

§ 371 Date: Aug. 27, 2019

(51) Int. Cl. G06K 9/00; G06F 16/58; G06F 3/01; G06T 7/70; G06T 19/00

(52) U.S. Cl. CPC G06K 9/00671; G06K 9/00295; G06K 9/00771; G06T 19/006; G06F 3/011; G06T 7/70; G06F 16/5866

(57) ABSTRACT

Technologies are described for enhanced target tracking through augmented reality (AR) in a surveillance environment. Complementary augmented reality features may be provided for enhanced connection between a control center and security personnel in the field. A target person to be tracked in a surveillance environment may be identified and whether a face of the target person is visible to a security personnel determined. If the face of the target person is at least partially not visible to the security personnel, augmentation information associated with the target person may be determined. The augmentation information may be provided to an AR device associated with the security personnel to be displayed by the AR device in conjunction with the target person. Additional information such as background information associated with the target person or analyzed mood information may also be provided to the security personnel.

### BACKGROUND

Unless otherwise indicated herein, the materials described in this section are not prior art to the claims in this application and are not admitted to be prior art by inclusion in this section.

Security environments such as concerts, sports events, and other large gatherings may be monitored by a number of security personnel on the ground, a number of surveillance devices (e.g., cameras), and a control center for coordinating security operations. A significant part of security surveillance involves observation of people with a goal of identifying suspicious people and tracking them through a crowd, for example.

Substantial information may be gathered by simply observing a face of a target person. Security personnel in the field may not always have full visibility of a target person's face. Furthermore, background information associated with a target person that may assist security personnel in the field to make quick decisions, but that information may not always be available to the security personnel.

### SUMMARY

The present disclosure generally describes techniques for enhanced target tracking through augmented reality in surveillance environments.

According to some examples, a method for enhanced target tracking through augmented reality in a surveillance environment is described. The method may include identifying a target person to be tracked in a surveillance environment; determining whether a face of the target person is visible to a security personnel; identifying augmentation information associated with the target person responsive to a determination that the face of the target person is at least partially not visible to the security personnel; and providing the augmentation information to an augmented reality (AR) device associated with the security personnel to be displayed in conjunction with the target person by the AR device.

According to other examples, an apparatus for enhanced target tracking through augmented reality in a surveillance environment is described. The apparatus may include a communication interface configured to facilitate communication between the apparatus, a plurality of image capture devices in the surveillance environment, an augmented reality (AR) device associated with a security personnel, and a data store; and a processor coupled to the communication interface. The processor may be configured to perform or control performance of identify a target person to be tracked in the surveillance environment; determine whether a face of the target person is visible to a security personnel; identify augmentation information associated with the target person responsive to a determination that the face of the target person is at least partially not visible to the security personnel; and provide, through the communication interface, the augmentation information to the AR device associated with the security personnel to be displayed in conjunction with the target person by the AR device.

According to further examples, a surveillance system for enhanced target tracking through augmented reality in a surveillance environment is described. The system may include a plurality of image capture devices configured to monitor the surveillance environment; a data store configured to store surveillance related data; an augmented reality (AR) device associated with a security personnel; and a server communicatively coupled to the plurality of image capture devices, the data store, and the AR device. The server may include a communication interface configured to facilitate communication between the server and the plurality of image capture devices, the data store, and the AR device; and a processor coupled to the communication interface. The processor may be configured to perform or control performance of: identify a target person to be tracked in the surveillance environment; determine whether a face of the target person is visible to the security personnel; identify augmentation information associated with the target person responsive to a determination that the face of the target person is at least partially not visible to the security personnel; and provide, through the communication interface, the augmentation information to the AR device associated with the security personnel to be displayed in conjunction with the target person by the AR device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example environment, where enhanced target tracking through augmented reality in surveillance environments may be implemented;

FIG. 2 includes a conceptual illustration of another example environment, where enhanced target tracking through augmented reality in surveillance environments may be implemented;

FIG. 3 illustrates marking of a target in a crowd for tracking in a system for enhanced target tracking through augmented reality in surveillance environments;

FIG. 4A through FIG. 4D illustrate various example implementations of enhanced target tracking through augmented reality in surveillance environments;

FIG. 5 illustrates components and interactions in an example system for implementing enhanced target tracking through augmented reality in surveillance environments;

FIG. 6 illustrates a computing device, which may be used for enhanced target tracking through augmented reality in surveillance environments;

FIG. 7 is a flow diagram illustrating an example method for enhanced target tracking through augmented reality in surveillance environments that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to enhanced target tracking through augmented reality in surveillance environments.

Briefly stated, technologies are generally described for enhanced target tracking through augmented reality (AR) in a surveillance environment. Complementary augmented reality features may be provided for enhanced connection between a control center and security personnel in the field. A target person to be tracked in a surveillance environment may be identified and whether a face of the target person is visible to a security personnel may be determined. If the face of the target person is at least partially not visible to the security personnel, augmentation information associated with the target person may be determined. The augmentation information may be provided to an AR device associated with the security personnel to be displayed by the AR device in conjunction with the target person. Additional information such as background information associated with the target person or analyzed mood information may also be provided to the security personnel.

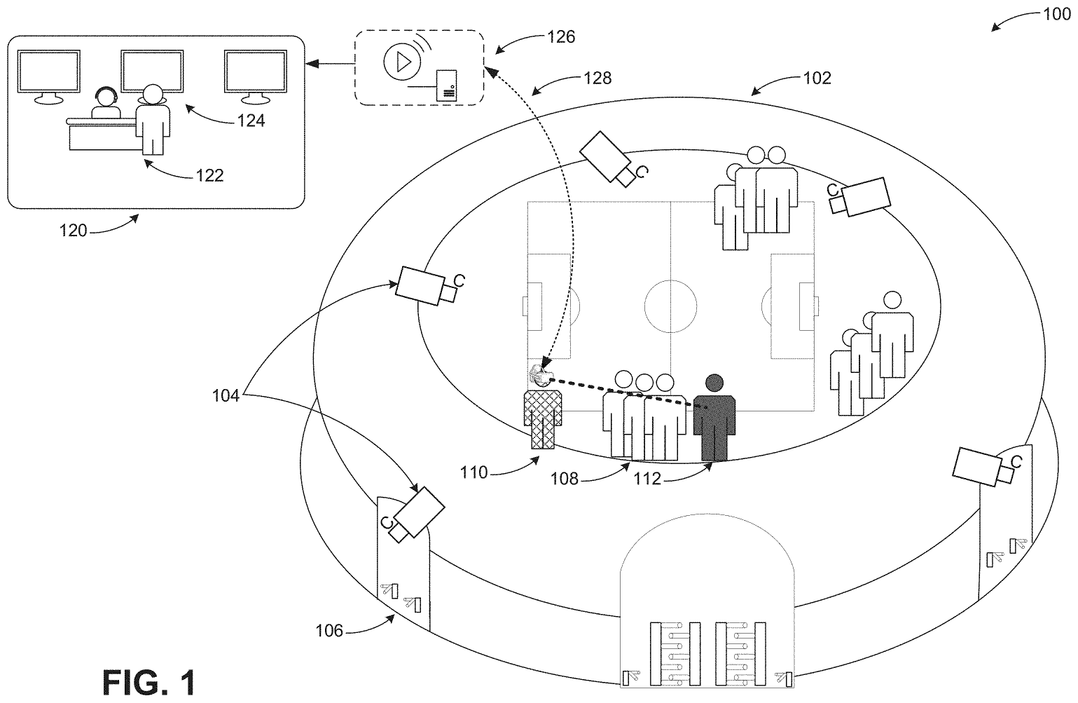

FIG. 1 includes a conceptual illustration of an example environment, where enhanced target tracking through augmented reality in surveillance environments may be implemented, arranged in accordance with at least some embodiments described herein.

As shown in diagram 100, a surveillance environment may be a sports arena 102, for example. To ensure safety in large gatherings at the sports arena 102, a number of measures may be taken including surveillance of the crowds at various locations such as entrances 106, gathering areas, etc. by fixed or mobile image capture devices 104. Image capture devices 104 may include fixed cameras, swivel cameras, cameras integrated to other devices (e.g., smart phones, wall displays, etc.), and other forms of image capture devices capable of capturing still images or videos.

In addition to automated systems like image capture devices 104, a surveillance system may include security personnel 110 who may walk among the crowds 108 and observe the people. When the security personnel 110 observes a crowd 108, they may focus on a target person 112. In other examples, a security application managing the surveillance system or a control center personnel may identify a target person 112 and ask the security personnel 110 to observe the target person. However, the view of the target person may not be informative. The target person's face may not be fully visible, the target person may wear clothing items or other accessories that may render their face at least partially invisible, etc. In some cases, just the face of the target person may not mean much to the security personnel and additional information may be useful for surveillance purposes.

In some examples, complementary augmented reality features may be provided for enhanced connection between a control center 120 and the security personnel 110 in the field. A target person 112 to be tracked in the surveillance environment 102 may be identified and whether a face of the target person 112 is visible to a security personnel may be determined. If the face of the target person is at least partially not visible to the security personnel 110, augmentation information associated with the target person 112 may be determined. The augmentation information may include an image or a video of the face of the target person 112 captured by an image capture device of the surveillance system, a recent image or video, identification information, or background information. The augmentation information may be provided 128 by a media server 126 of the surveillance system to an AR device associated with the security personnel 110 to be displayed by the AR device in conjunction with the target person 112. In yet other examples, the augmentation information may be provided to the AR device associated with the security personnel even if the face of the target person is visible to the security personnel. In such cases, the augmentation information may include background information, personal information, and/or any other relevant information associated with the target person that may help the security personnel in their surveillance tasks.

The target person 112 may be identified at the control center 120 by the control center personnel 122 or by the security personnel 110. Observing the surveillance environment 102 from a variety of angles on displays 124, the control center personnel 122 may select an image or video of the target person and/or other information associated with the target person to be sent to the security personnel as augmentation information.

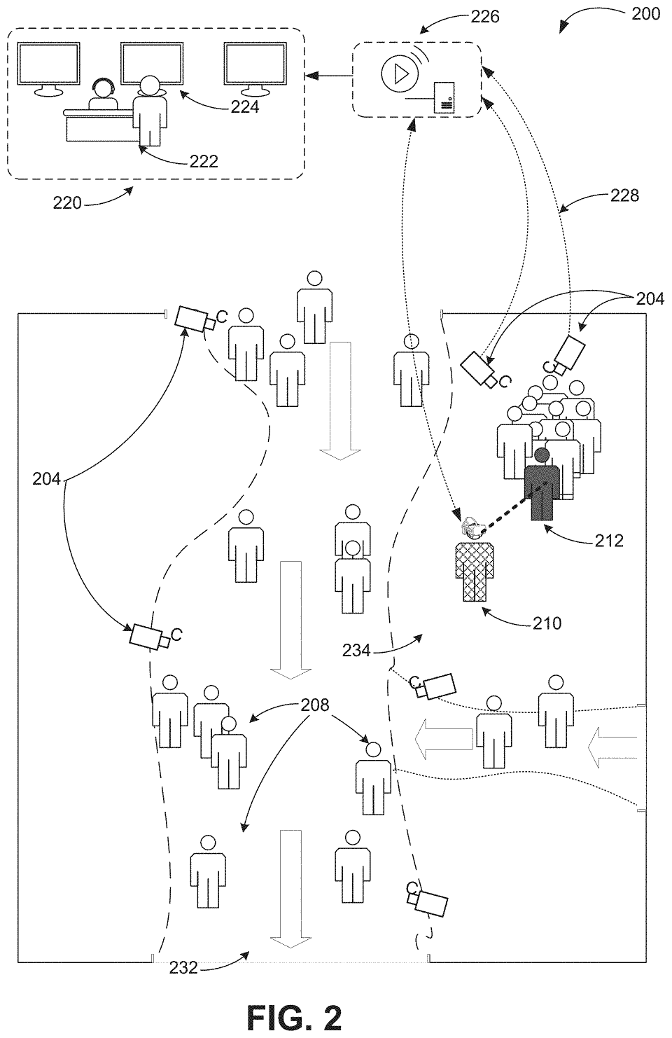

FIG. 2 includes a conceptual illustration of another example environment, where enhanced target tracking through augmented reality in surveillance environments may be implemented, arranged in accordance with at least some embodiments described herein.

Diagram 200 shows another example surveillance environment, where crowds 208 may gather on streets and other areas. Thus, surveillance cameras 204 may observe the crowds 208 along the streets, at connection points 232, and other gathering areas 234 (e.g., parks along the streets). A target person 212 may be identified at the control center 220 by the control center personnel 222 or by the security personnel 210. Observing the surveillance environment from a variety of angles on displays 224, the control center personnel 222 may select an image or video of the target person and/or other information associated with the target person to be sent to the security personnel 210 as augmentation information.

Images or videos captured by the surveillance cameras 204 may be transmitted (228) to a media server 226 of the surveillance system. The same media server 226 or another server of the surveillance system may provide the augmentation information (such as the captured image or video) to an AR device of the security personnel 210 to be superimposed with a view of the target person 212 to provide the security personnel useful information associated with the target person during the observation.

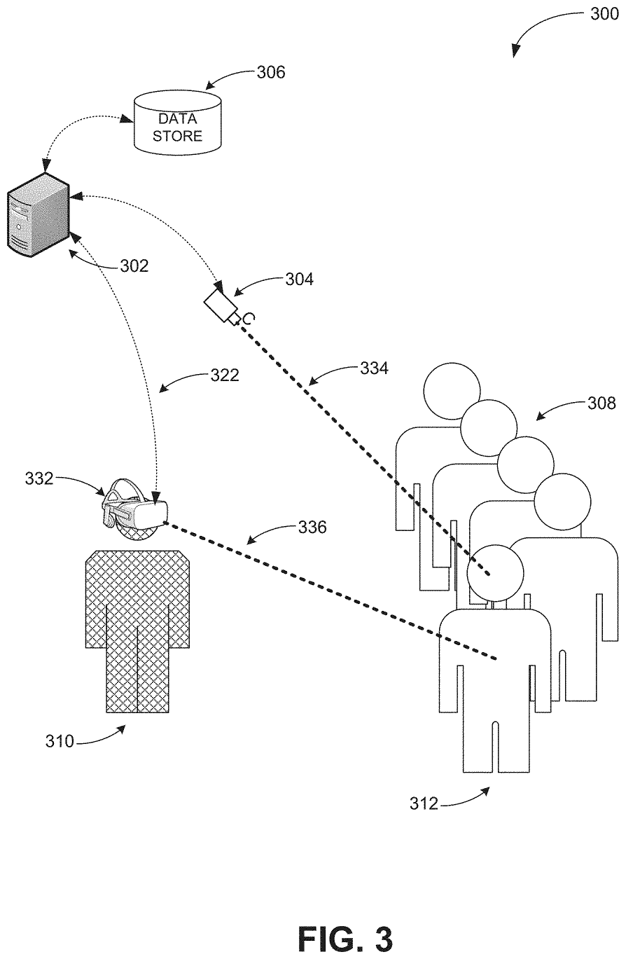

FIG. 3 illustrates marking of a target in a crowd for tracking in a system for enhanced target tracking through augmented reality in surveillance environments, arranged in accordance with at least some embodiments described herein.

According to some examples, enhanced target tracking through augmented reality in a surveillance environment may be accomplished by identifying a target person 312 to be tracked among other people 308 in a surveillance environment and determining whether a face of the target person 312 is visible to a security personnel 310. If the face of the target person 312 is at least partially not visible to the security personnel, augmentation information associated with the target person 312 may be determined. The augmentation information may be provided (322) to an AR device 332 associated with the security personnel 310 to be displayed in conjunction (336) with the target person 312 by the AR device 332.

One or more image capture devices such as camera 304 capable to capture an image or a video of the face of the target person 312 may be attempted to be identified. If the image capture devices (camera 304) capable to capture the image or the video of the face of the target person are identified, captured image or the captured video 334 of the face of the target person 312 may be received from the identified camera 304. The camera 304 and/or other image capture devices of the surveillance system may also be used to track the target person 312. The AR device 332 may include a mobile computer, a wearable computer, a pair of AR glasses, or similar devices.

The augmentation information may be provided to the AR device 332 associated with the security personnel 310 as the captured image or video 334 of the target person 312. If no image capture devices capable to capture the image or the video of the face of the target person are identified, a recent image or a recent video of the face of the target person 312 may be retrieved from a data store 306 and provided (322) to the AR device 332 associated with the security personnel as the augmentation information. In other examples, identification information associated with the target person 312 may be retrieved from a data store (e.g., data store 306) if no image capture devices capable to capture the image or the video of the face of the target person 312 are identified and the identification information may be provided associated with the target person 312 to the AR device 332. Such identification information associated with the target person 312 may include a name, an age, a height, a weight, a hair color, an eye color, and/or a facial feature. Furthermore, information associated with the target person 312 such as places visited over a certain period in the past (e.g., past several hours, past several days), job experience, criminal record, and similar information may also be provided to the security personnel 310.

The target person 312 may be identified by a security application executed on a server 302 associated with the surveillance environment or by the security personnel 310 and reported to the security application. In further examples, an image or a video of the face of the target person 312 may be captured through an image capture device. The image or the video of the face of the target person may be analyzed to identify a mood of the target person 312, and the identified mood may be provided to the AR device 332 associated with the security personnel 310.

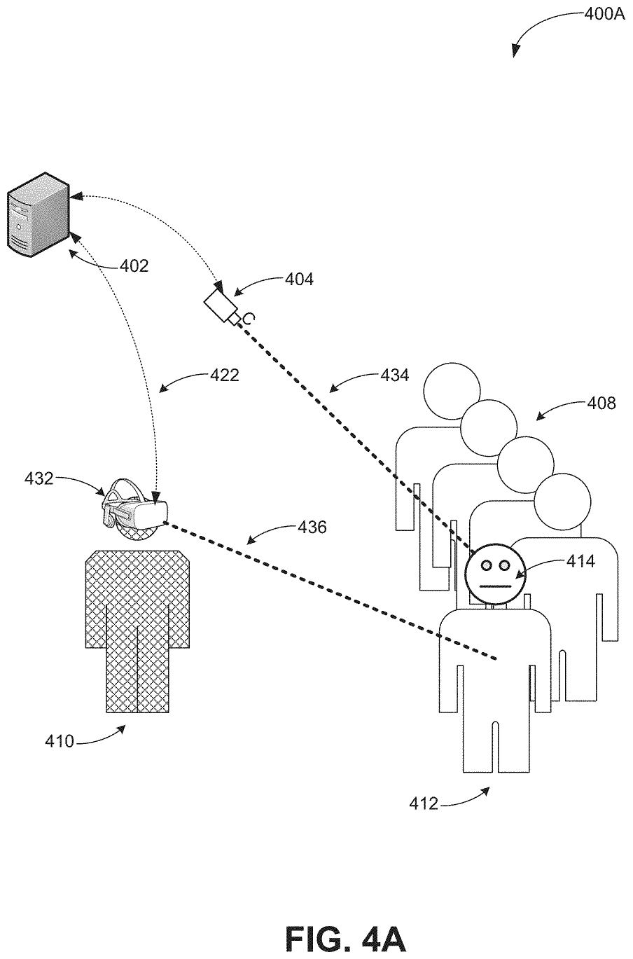

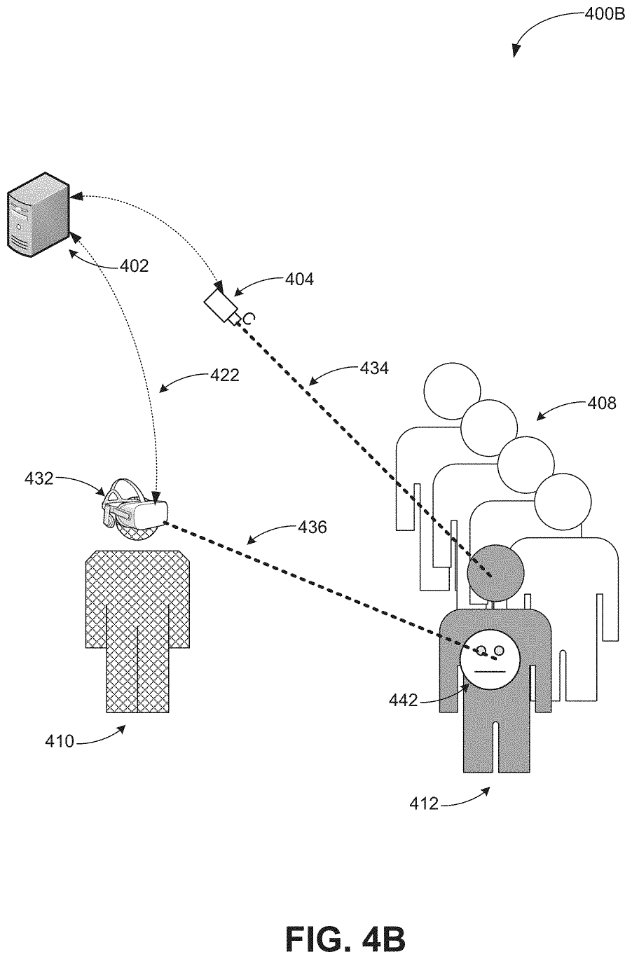

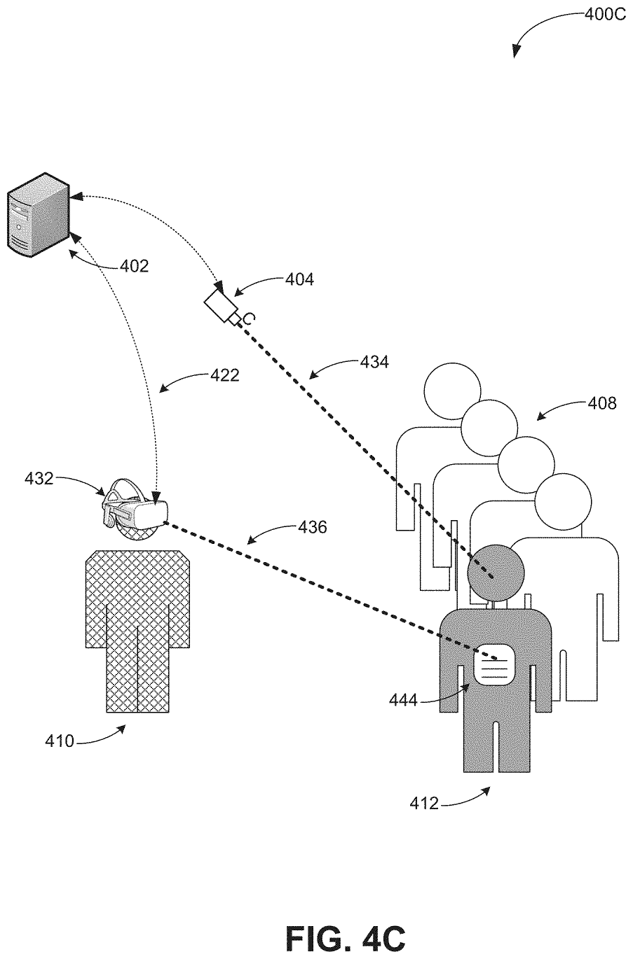

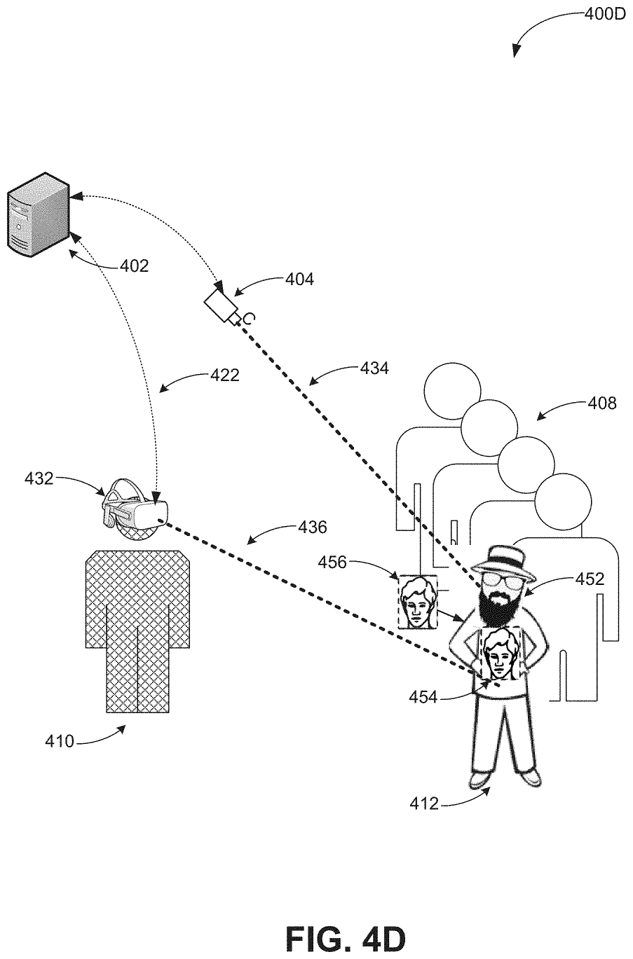

FIG. 4A through FIG. 4D illustrate various example implementations of enhanced target tracking through augmented reality in surveillance environments, arranged in accordance with at least some embodiments described herein.

Diagram 400A of FIG. 4A shows capture 434 of an image of a face 414 of a target person 412 among other people 408 by a surveillance camera 404 and provision 422 of the image of the face 414 by a server 402 to an AR device (AR glasses 432) of a security personnel 410 who is observing 436 the target person 412, but unable to see the face 414 of the target person 412 clearly.

Whether the face 414 of the target person 412 is visible to the security personnel 410 may be determined based on whether the security personnel 410 is facing a back of the target person 412, whether lighting conditions allow the security personnel 410 to see the face 414 of the target person 412 clearly, whether the face 414 of the target person 412 is covered (e.g., the target person is wearing dark glasses or a scarf), whether facial features of the target person 412 are different compared to a recent image of the target person 412 (e.g., a beard), and/or based on some other factor(s) or combination(s) thereof.

Diagram 400B of FIG. 4B shows projection of augmentation information on the target person 412 by the AR glasses 432. In some examples, the augmentation information (e.g., the captured image of the face 414) may be provided to the AR glasses 432 associated with the security personnel 410 to be projected onto a back of a head or a torso 442 of the target person 412 by the AR glasses 432.

Diagram 400C of FIG. 4C shows projection of augmentation information 444 other than an image of the target person 412 on the target person 412 by the AR glasses 432. In some examples, identification information associated with the target person 412 may be retrieved from a data store if no image capture devices capable to capture the image or the video of the face of the target person 412 are identified. The identification information may be provided to the AR glasses 432. Such identification information associated with the target person 412 may include a name, an age, a height, a weight, a hair color, an eye color, and/or a facial feature. Furthermore, information associated with the target person 412 such as places visited over a certain period in the past (e.g., past several hours, past several days), job experience, criminal record, and similar information may also be provided to the security personnel 410 as augmentation information 444 to be displayed on the target person 412.

Diagram 400D of FIG. 4D shows an example scenario, where the face 452 of the target person 412 may be covered (e.g., the target person is wearing dark glasses and a hat), and/or facial features of the target person 412 may be different compared to a recent image of the target person 412 (e.g., a beard). In such a scenario, if a recent image of the target person's face is available, that image may be provided by the server 402 to the AR glasses 432 (or other AR device associated with the security personnel 410) to be displayed on a torso 454 of the target person 412 or as a label 456 in conjunction with the target person 412.

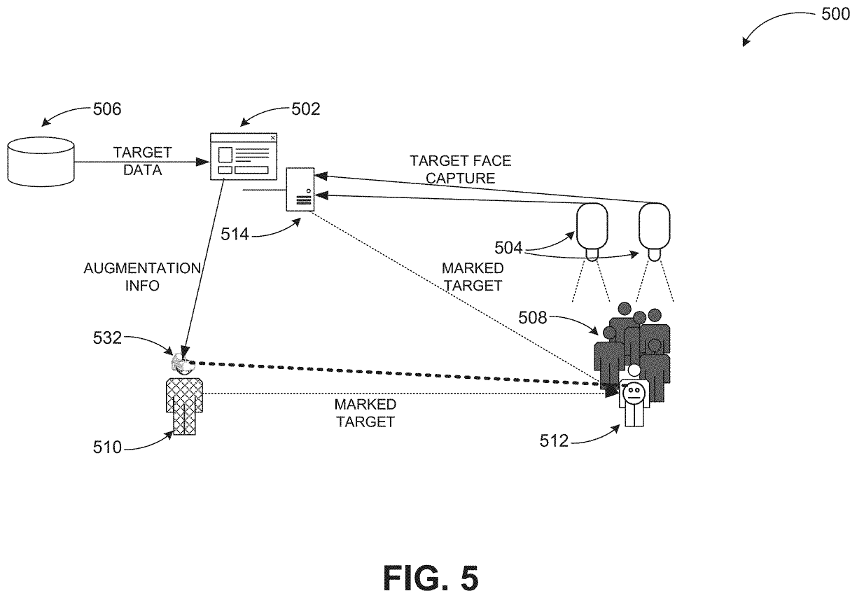

FIG. 5 illustrates components and interactions in an example system for implementing enhanced target tracking through augmented reality in surveillance environments, arranged in accordance with at least some embodiments described herein.

Some examples embodiments, as shown in diagram 500, may be implemented as a surveillance system for enhanced target tracking through augmented reality in a surveillance environment. An example system may include a number of image capture devices 504 configured to monitor the surveillance environment, a data store 506 configured to store surveillance related data, an AR device 532 associated with a security personnel 510, and a server 514 communicatively coupled to the image capture devices, the data store, and the AR device. The server 514 may execute a surveillance application 502 to manage security related operations in the surveillance environment. The server 514 may include a communication interface configured to facilitate communication between the server 514 and the image capture devices 504, the data store 506, and the AR device 532, and a processor coupled to the communication interface. The processor may perform or control performance of identification of a target person 512 to be tracked in the surveillance environment among other people 508 and determination of whether a face of the target person 512 is visible to a security personnel 510. The processor may also identify augmentation information associated with the target person 512 responsive to a determination that the face of the target person 512 is at least partially not visible to the security personnel 510 and provide, through the communication interface, the augmentation information to the AR device 532 associated with the security personnel 510 to be displayed in conjunction with the target person 512 by the AR device 532.

Other example embodiments may be implemented as an apparatus for enhanced target tracking through augmented reality in a surveillance environment. Such an apparatus may include a communication interface configured to facilitate communication between the apparatus, a number of image capture devices in the surveillance environment, an AR device associated with a security personnel, and a data store. The apparatus may also include a processor coupled to the communication interface, where the processor may perform or control performance of identification of a target person to be tracked in the surveillance environment and determination of whether a face of the target person is visible to a security personnel. The processor may also identify augmentation information associated with the target person responsive to a determination that the face of the target person is at least partially not visible to the security personnel and provide, through the communication interface, the augmentation information to the AR device associated with the security personnel to be displayed in conjunction with the target person by the AR device.

The examples provided in FIG. 1 through FIG. 5 are illustrated with specific systems, devices, applications, and scenarios. Embodiments are not limited to environments according to these examples. Enhanced target tracking through augmented reality in surveillance environments may be implemented in environments employing fewer or additional systems, devices, applications, and scenarios. Furthermore, the example systems, devices, applications, and scenarios shown in FIG. 1 through FIG. 5 may be implemented in a similar manner with other user interface or action flow sequences using the principles described herein.

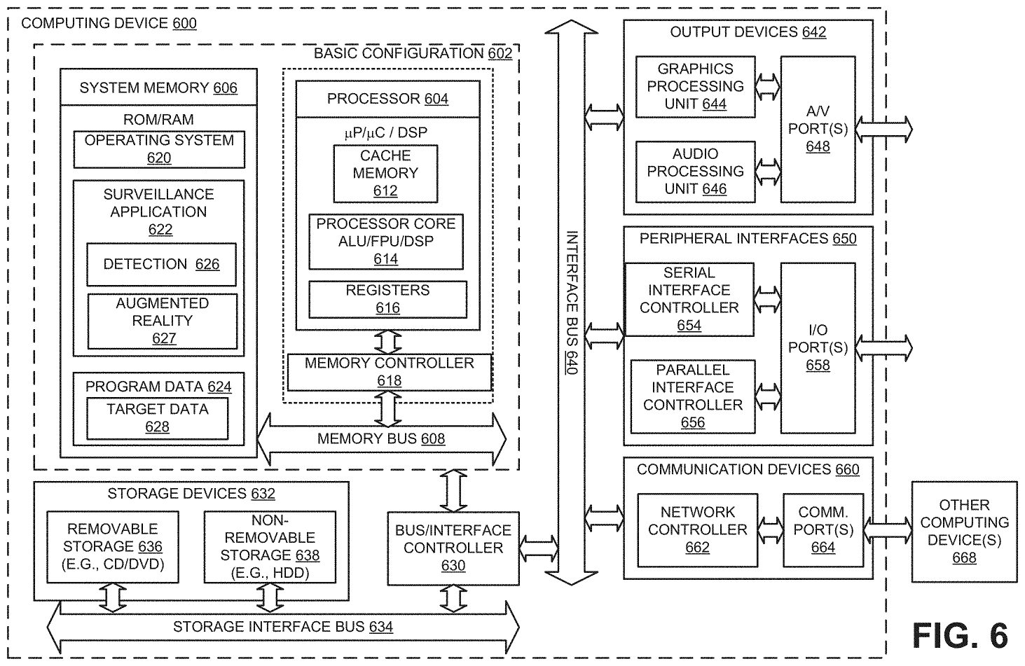

FIG. 6 illustrates a computing device, which may be used for enhanced target tracking through augmented reality in surveillance environments, arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include a detection component 626 to detect target people in a surveillance environment and gather information associated with the target people. The surveillance application 622 may also include an augmented reality component 627 to provide retrieved or captured information associated with the target people to AR devices of security personnel in the field to provide complementary information associated with the target people. The program data 624 may include, among other data, target data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 660 includes a network controller 662, which may be arranged to facilitate communications with one or more other computing devices 668 over a network communication link via one or more communication ports 664. The one or more other computing devices 668 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

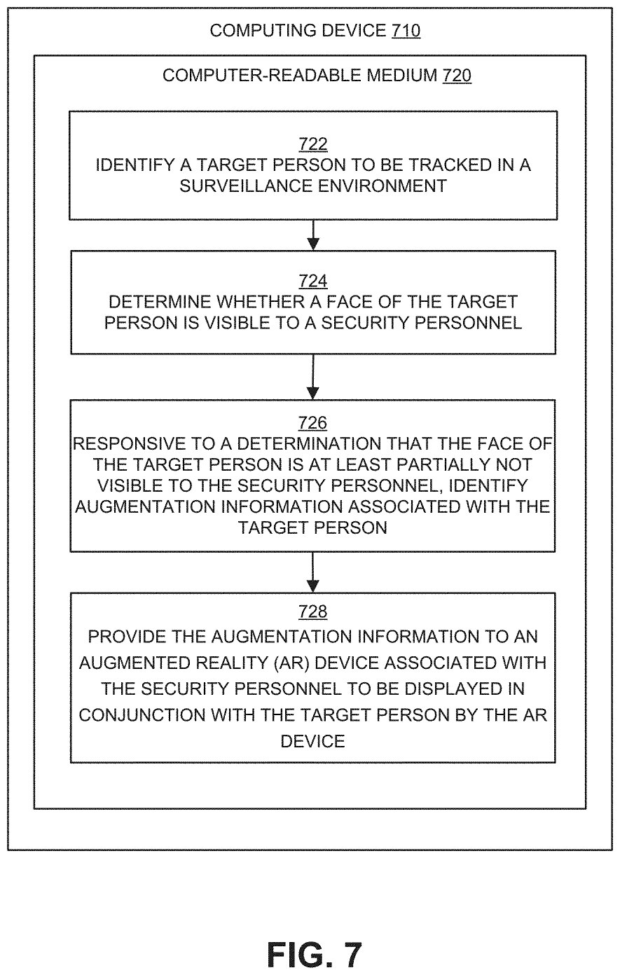

FIG. 7 is a flow diagram illustrating an example method for enhanced target tracking through augmented reality in surveillance environments that may be performed by a computing device such as the computing device in FIG. 6, arranged in accordance with at least some embodiments described herein.

Example methods may include one or more operations, functions, or actions as illustrated by one or more of blocks 722, 724, 726, and/or 728, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions, or actions, and need not necessarily be performed in the exact sequence as shown. The operations described in the blocks 722-728 may also be implemented through execution of computer-executable instructions stored in a computer-readable medium such as a computer-readable medium 720 of a computing device 710.

An example process for enhanced target tracking through augmented reality in a surveillance environment may begin with block 722, “IDENTIFY A TARGET PERSON TO BE TRACKED IN A SURVEILLANCE ENVIRONMENT”, where a target person in the surveillance environment (e.g., within a crowd at a sports arena, concert venue, or similar large gathering of people) may be identified by a security application executed on a server associated with the surveillance environment or by a security personnel and reported to the security application.

Block 722 may be followed by block 724, “DETERMINE WHETHER A FACE OF THE TARGET PERSON IS VISIBLE TO A SECURITY PERSONNEL”, where whether the face of the target person is visible to the security personnel may be determined based on whether the security personnel is facing a back of the target person, whether lighting conditions allow the security personnel to see the face of the target person clearly, whether the face of the target person is covered (e.g., the target person is wearing dark glasses or a scarf), and/or whether facial features of the target person are different compared to a recent image of the target person (e.g., a beard).

Block 724 may be followed by block 726, “RESPONSIVE TO A DETERMINATION THAT THE FACE OF THE TARGET PERSON IS AT LEAST PARTIALLY NOT VISIBLE TO THE SECURITY PERSONNEL, IDENTIFY AUGMENTATION INFORMATION ASSOCIATED WITH THE TARGET PERSON”, where an image or video of a face of the target person, an identification information, or other background information may be determined as augmentation information. Identification information associated with the target person may include a name, an age, a height, a weight, a hair color, an eye color, and/or a facial feature. Furthermore, information associated with the target person such as places visited over a certain period in the past (e.g., past several hours, past several days), job experience, criminal record, and similar information may be identified as background information to be used for augmenting the security personnel's view of the target person.

Block 726 may be followed by block 728, “PROVIDE THE AUGMENTATION INFORMATION TO A/V AUGMENTED REALITY (AR) DEVICE ASSOCIATED WITH THE SECURITY PERSONNEL TO BE DISPLAYED IN CONJUNCTION WITH THE TARGET PERSON BY THE AR DEVICE”, where the augmentation information may be transmitted to the security personnel's AR device to be displayed in conjunction with the view of the security personnel of the target person. In some examples, the augmentation information may be provided to the AR device associated with the security personnel to be projected onto a back of a head or a torso of the target person by the AR device. In other examples, the augmentation information may be provided to the AR device associated with the security personnel to be projected as a label associated with the target person by the AR device.

The operations included in the example process are for illustration purposes. Enhanced target tracking through augmented reality in surveillance environments may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

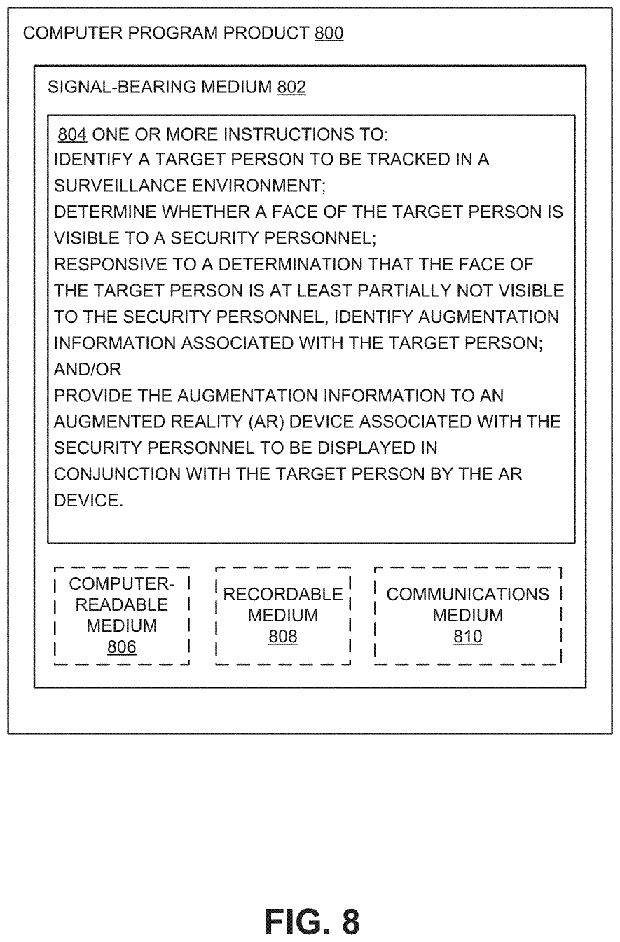

FIG. 8 illustrates a block diagram of an example computer program product, some of which are arranged in accordance with at least some embodiments described herein.

In some examples, as shown in FIG. 8, a computer program product 800 may include a signal-bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal-bearing medium 802 to perform actions associated with enhanced target tracking through augmented reality in surveillance environments as described herein. Some of those instructions 804 may include, for example, one or more instructions to identify a target person to be tracked in a surveillance environment; determine whether a face of the target person is visible to a security personnel; responsive to a determination that the face of the target person is at least partially not visible to the security personnel, identify augmentation information associated with the target person; and/or provide the augmentation information to an augmented reality (AR) device associated with the security personnel to be displayed in conjunction with the target person by the AR device according to some embodiments described herein.

In some implementations, the signal-bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal-bearing medium 802 may encompass recordable medium 808, such as, but not limited to, memory, read/write (R/W) CDs, R/W DVDs, etc. In some implementations, the signal-bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal-bearing medium 802 is conveyed by the communications medium 810 (e.g., a wireless communications medium conforming with the IEEE 802.11 standard).

According to some examples, a method for enhanced target tracking through augmented reality in a surveillance environment is described. The method may include identifying a target person to be tracked in a surveillance environment; determining whether a face of the target person is visible to a security personnel; identifying augmentation information associated with the target person responsive to a determination that the face of the target person is at least partially not visible to the security personnel; and providing the augmentation information to an augmented reality (AR) device associated with the security personnel to be displayed in conjunction with the target person by the AR device.

According to other examples, the method may also include attempting to identify one or more image capture devices capable to capture an image or a video of the face of the target person; and responsive to identifying the one or more image capture devices capable to capture the image or the video of the face of the target person, receiving the captured image or the captured video of the face of the target person from the identified one or more image capture devices. Providing the augmentation information to the AR device associated with the security personnel to be displayed in conjunction with the target person by the AR device may include providing the captured image or video of the target person to the AR device. The method may further include responsive to failing to identify the one or more image capture devices capable to capture the image or the video of the face of the target person, retrieving a recent image or a recent video of the face of the target person from a data store.

According to further examples, providing the augmentation information to the AR device associated with the security personnel to be displayed in conjunction with the target person by the AR device may include providing the retrieved recent image or the retrieved recent video of the face of the target person to the AR device. The method may further include responsive to failing to identify the one or more image capture devices capable to capture the image or the video of the face of the target person, retrieving information associated with the target person from a data store. Providing the augmentation information to the AR device associated with the security personnel to be displayed in conjunction with the target person by the AR device may include providing the retrieved information associated with the target person to the AR device. The information associated with the target person may include one or more of a name, an age, a height, a weight, a hair color, an eye color, a facial feature, places visited by the target person over a particular period of time, a job experience, or a criminal record.

According to yet other examples, providing the augmentation information to the AR device associated with the security personnel to be displayed in conjunction with the target person by the AR device may include providing the augmentation information to the AR device associated with the security personnel to be projected onto a back of a head or a torso of the target person by the AR device. Providing the augmentation information to the AR device associated with the security personnel to be displayed in conjunction with the target person by the AR device comprises may also include providing the augmentation information to the AR device associated with the security personnel to be projected as a label associated with the target person by the AR device. Determining whether the face of the target person is visible to the security personnel may include determining whether the security personnel is facing a back of the target person; determining whether lighting conditions allow the security personnel to see the face of the target person clearly; determining whether the face of the target person is covered; and/or determining whether facial features of the target person are different compared to a recent image of the target person.

According to yet further examples, identifying the target person to be tracked in the surveillance environment may include identifying the target person by a security application executed on a server associated with the surveillance environment. Identifying the target person to be tracked in the surveillance environment may include receiving an identification of the target person from the security personnel at a security application executed on a server associated with the surveillance environment. The method may also include capturing an image or a video of the face of the target person through an image capture device; analyzing the image or the video of the face of the target person to identify a mood of the target person; and providing the identified mood to the AR device associated with the security personnel.

According to other examples, an apparatus for enhanced target tracking through augmented reality in a surveillance environment is described. The apparatus may include a communication interface configured to facilitate communication between the apparatus, a plurality of image capture devices in the surveillance environment, an augmented reality (AR) device associated with a security personnel, and a data store; and a processor coupled to the communication interface. The processor may be configured to perform or control performance of identify a target person to be tracked in the surveillance environment; determine whether a face of the target person is visible to a security personnel; identify augmentation information associated with the target person responsive to a determination that the face of the target person is at least partially not visible to the security personnel; and provide, through the communication interface, the augmentation information to the AR device associated with the security personnel to be displayed in conjunction with the target person by the AR device.

According to some examples, the processor may be configured to perform or control performance of attempt to identify one or more image capture devices capable to capture an image or a video of the face of the target person; and responsive to identification of the one or more image capture devices capable to capture the image or the video of the face of the target person, receive, through the communication interface, the captured image or the captured video of the face of the target person from the identified one or more image capture devices. The processor may also be configured to perform or control performance of provide, through the communication interface, the captured image or video of the target person as the augmentation information to the AR device. The processor may further be configured to perform or control performance of responsive to a failure to identify the one or more image capture devices capable to capture the image or the video of the face of the target person, retrieve, through the communication interface, a recent image or a recent video of the face of the target person from the data store. The processor may also be configured to perform or control performance of provide, through the communication interface, the retrieved recent image or the retrieved recent video of the face of the target person as the augmentation information to the AR device.

According to other examples, the processor may be configured to perform or control performance of responsive to a failure to identify the one or more image capture devices capable to capture the image or the video of the face of the target person, retrieve, through the communication interface, information associated with the target person from the data store. The processor may also be configured to perform or control performance of provide, through the communication interface, the retrieved information associated with the target person as the augmentation information to the AR device. The information associated with the target person may include one or more of a name, an age, a height, a weight, a hair color, an eye color, a facial feature, places visited by the target person over a particular period of time, a job experience, or a criminal record. The processor may be configured to perform or control performance of provide, through the communication interface, the augmentation information to the AR device associated with the security personnel to be projected onto a back of a head or a torso of the target person by the AR device.

According to yet other examples, the processor may be configured to perform or control performance of provide, through the communication interface, the augmentation information to the AR device associated with the security personnel to be projected as a label associated with the target person by the AR device. The processor may further be configured to perform or control performance of determine whether the face of the target person is visible to the security personnel through one or more of a determination of whether the security personnel is facing a back of the target person; a determination of whether lighting conditions allow the security personnel to see the face of the target person clearly; a determination of whether the face of the target person is covered; and a determination of whether facial features of the target person are different compared to a recent image of the target person.

According to some examples, the processor may be configured to perform or control performance of identify the target person to be tracked in the surveillance environment based on an analysis of one or more images or video received, through the communication interface, from the plurality of image capture devices. The processor may also be configured to perform or control performance of identify the target person to be tracked in the surveillance environment based on information received, through the communication interface, from the security personnel. The processor may be further configured to perform or control performance of receive, through the communication interface, a captured image or a captured video of the face of the target person from one or more of the plurality of image capture devices; analyze the captured image or the captured video of the face of the target person to identify a mood of the target person; and transmit, through the communication interface, information associated with the identified mood to the AR device associated with the security personnel.

According to further examples, a surveillance system for enhanced target tracking through augmented reality in a surveillance environment is described. The system may include a plurality of image capture devices configured to monitor the surveillance environment; a data store configured to store surveillance related data; an augmented reality (AR) device associated with a security personnel; and a server communicatively coupled to the plurality of image capture devices, the data store, and the AR device. The server may include a communication interface configured to facilitate communication between the server and the plurality of image capture devices, the data store, and the AR device; and a processor coupled to the communication interface. The processor may be configured to perform or control performance of: identify a target person to be tracked in the surveillance environment; determine whether a face of the target person is visible to the security personnel; identify augmentation information associated with the target person responsive to a determination that the face of the target person is at least partially not visible to the security personnel; and provide, through the communication interface, the augmentation information to the AR device associated with the security personnel to be displayed in conjunction with the target person by the AR device.

According to some examples, the processor may be configured to perform or control performance of attempt to identify one or more image capture devices capable to capture an image or a video of the face of the target person; and responsive to identification of the one or more image capture devices capable to capture the image or the video of the face of the target person, receive, through the communication interface, the captured image or the captured video of the face of the target person from the identified one or more image capture devices. The processor may also be configured to perform or control performance of provide, through the communication interface, the captured image or video of the target person as the augmentation information to the AR device. The processor may further be configured to perform or control performance of responsive to a failure to identify the one or more image capture devices capable to capture the image or the video of the face of the target person, retrieve, through the communication interface, a recent image or a recent video of the face of the target person from the data store. The processor may be configured to perform or control performance of provide, through the communication interface, the retrieved recent image or the retrieved recent video of the face of the target person as the augmentation information to the AR device.

According to other examples, the processor may be configured to perform or control performance of responsive to a failure to identify the one or more image capture devices capable to capture the image or the video of the face of the target person, retrieve, through the communication interface, information associated with the target person from the data store. The processor may also be configured to perform or control performance of provide, through the communication interface, the retrieved information associated with the target person as the augmentation information to the AR device. The information associated with the target person may include one or more of a name, an age, a height, a weight, a hair color, an eye color, a facial feature, places visited by the target person over a particular period of time, a job experience, or a criminal record. The processor may be configured to perform or control performance of provide, through the communication interface, the augmentation information to the AR device associated with the security personnel to be projected onto a back of a head or a torso of the target person by the AR device. The processor may also be configured to perform or control performance of provide, through the communication interface, the augmentation information to the AR device associated with the security personnel to be projected as a label associated with the target person by the AR device.

According to further examples, the processor may be configured to perform or control performance of determine whether the face of the target person is visible to the security personnel through one or more of a determination of whether the security personnel is facing a back of the target person; a determination of whether lighting conditions allow the security personnel to see the face of the target person clearly; a determination of whether the face of the target person is covered; and a determination of whether facial features of the target person are different compared to a recent image of the target person. The processor may further be configured to perform or control performance of identify the target person to be tracked in the surveillance environment based on an analysis of one or more images or video received, through the communication interface, from the plurality of image capture devices.

According to yet other examples, the processor may be configured to perform or control performance of identify the target person to be tracked in the surveillance environment based on information received, through the communication interface, from the security personnel. The processor may be further configured to perform or control performance of receive, through the communication interface, a captured image or a captured video of the face of the target person from one or more of the plurality of image capture devices; analyze the captured image or the captured video of the face of the target person to identify a mood of the target person; and transmit, through the communication interface, information associated with the identified mood to the AR device associated with the security personnel. The AR device may include a mobile computer, a wearable computer, or a pair of AR glasses.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method for enhanced target tracking through augmented reality (AR) in a surveillance environment, the method comprising:
identifying a target person to be tracked in a surveillance environment;
determining whether a face of the target person is visible to a security personnel;
responsive to a determination that the face of the target person is at least partially not visible to the security personnel, identifying augmentation information associated with the target person; and
providing the augmentation information to an AR device associated with the security personnel to be displayed in conjunction with the target person by the AR device.

2. The method of claim 1, further comprising:
attempting to identify one or more image capture devices capable to capture an image or a video of the face of the target person; and
responsive to identifying the one or more image capture devices capable to capture the image or the video of the face of the target person, receiving the captured image or the captured video of the face of the target person from the identified one or more image capture devices.

3. The method of claim 2, wherein providing the augmentation information to the AR device associated with the security personnel to be displayed in conjunction with the target person by the AR device comprises:
providing the captured image or the captured video of the face of the target person to the AR device.

4. The method of claim 2, further comprising:
responsive to failing to identify the one or more image capture devices capable to capture the image or the video of the face of the target person, retrieving a recent image or a recent video of the face of the target person from a data store; and
providing the retrieved recent image or the retrieved recent video of the face of the target person to the AR device.

5. (canceled)

6. The method of claim 2, further comprising:
responsive to failing to identify the one or more image capture devices capable to capture the image or the video of the face of the target person, retrieving information associated with the target person from a data store; and
providing the retrieved information associated with the target person to the AR device.

7. (canceled)

8. The method of claim 2, further comprising:
responsive to failing to identify the one or more image capture devices capable to capture the image or the video of the face of the target person, retrieving information associated with the target person from a data store, wherein the information associated with the target person comprises one or more of a name, an age, a height, a weight, a hair color, an eye color, a facial feature, places visited by the target person over a particular period of time, a job experience, or a criminal record.

9. The method of claim 1, wherein providing the augmentation information to the AR device associated with the security personnel to be displayed in conjunction with the target person by the AR device comprises:
providing the augmentation information to the AR device associated with the security personnel to be projected onto a back of a head or a torso of the target person by the AR device or to be projected as a label associated with the target person by the AR device.

10. (canceled)

11. The method of claim 1, wherein determining whether the face of the target person is visible to the security personnel comprises one or more of:
determining whether the security personnel is facing a back of the target person;
determining whether lighting conditions allow the security personnel to see the face of the target person clearly;
determining whether the face of the target person is covered; and
determining whether facial features of the target person are different compared to a recent image of the target person.

12. (canceled)

13. (canceled)

14. The method of claim 1, further comprising:
capturing an image or a video of the face of the target person through an image capture device;
analyzing the image or the video of the face of the target person to identify a mood of the target person; and
providing the identified mood to the AR device associated with the security personnel.

15. The method of claim 1, further comprising:
identifying another augmentation information associated with the target person, wherein the other augmentation information includes one or more of background information, context information, and identification information associated with the target person; and
providing the other augmentation information to the AR device associated with the security personnel when the face of the target person is at least partially visible to the security personnel.

16. An apparatus for enhanced target tracking through augmented reality (AR) in a surveillance environment, the apparatus comprising:
a communication interface configured to facilitate communication between the apparatus, a plurality of image capture devices in the surveillance environment, an AR device associated with a security personnel, and a data store; and
a processor coupled to the communication interface, wherein the processor is configured to perform or control performance of:
identify a target person to be tracked in the surveillance environment;
determine whether a face of the target person is visible to a security personnel;
responsive to a determination that the face of the target person is at least partially not visible to the security personnel, identify augmentation information associated with the target person; and
provide, through the communication interface, the augmentation information to the AR device associated with the security personnel to be displayed in conjunction with the target person by the AR device.

17. The apparatus of claim 16, wherein the processor is configured to perform or control performance of:
attempt to identify one or more image capture devices capable to capture an image or a video of the face of the target person;
responsive to identification of the one or more image capture devices capable to capture the image or the video of the face of the target person, receive, through the communication interface, the captured image or the captured video of the face of the target person from the identified one or more image capture devices; and
provide, through the communication interface, the captured image or video of the target person as the augmentation information to the AR device.

18. (canceled)

19. The apparatus of claim 16, wherein the processor is configured to perform or control performance of:
attempt to identify one or more image capture devices capable to capture an image or a video of the face of the target person;
responsive to a failure to identify the one or more image capture devices capable to capture the image or the video of the face of the target person, retrieve, through the communication interface, a recent image or a recent video of the face of the target person from the data store; and
provide, through the communication interface, the retrieved recent image or the retrieved recent video of the face of the target person as the augmentation information to the AR device.

20. (canceled)

21. The apparatus of claim 17, wherein the processor is configured to perform or control performance of:
attempt to identify one or more image capture devices capable to capture an image or a video of the face of the target person;
responsive to a failure to identify the one or more image capture devices capable to capture the image or the video of the face of the target person, retrieve, through the communication interface, information associated with the target person from the data store; and
provide, through the communication interface, the retrieved information associated with the target person as the augmentation information to the AR device.

22. (canceled)

23. The apparatus of claim 24 16, further comprising:
attempt to identify one or more image capture devices capable to capture an image or a video of the face of the target person; and
responsive to a failure to identify the one or more image capture devices capable to capture the image or the video of the face of the target person, retrieve, through the communication interface, information associated with the target person from the data store, wherein the information associated with the target person comprises one or more of a name, an age, a height, a weight, a hair color, an eye color, a facial feature, places visited by the target person over a particular period of time, a job experience, or a criminal record.

24. The apparatus of claim 16, wherein the processor is configured to perform or control performance of:
provide, through the communication interface, the augmentation information to the AR device associated with the security personnel to be projected onto a back of a head or a torso of the target person by the AR device or to be projected as a label associated with the target person by the AR device.

25. (canceled)

26. The apparatus of claim 16, wherein the processor is configured to perform or control performance of:
determine whether the face of the target person is visible to the security personnel through one or more of:
a determination of whether the security personnel is facing a back of the target person;
a determination of whether lighting conditions allow the security personnel to see the face of the target person clearly;
a determination of whether the face of the target person is covered; and
a determination of whether facial features of the target person are different compared to a recent image of the target person.

27. The apparatus of claim 16, wherein the processor is configured to perform or control performance of:
identify the target person to be tracked in the surveillance environment based on an analysis of one or more images or video received, through the communication interface, from the plurality of image capture devices; or
identify the target person to be tracked in the surveillance environment based on information received, through the communication interface, from the security personnel.

28. (canceled)

29. The apparatus of claim 16, wherein the processor is further configured to perform or control performance of:
receive, through the communication interface, a captured image or a captured video of the face of the target person from one or more of the plurality of image capture devices;
analyze the captured image or the captured video of the face of the target person to identify a mood of the target person; and
transmit, through the communication interface, information associated with the identified mood to the AR device associated with the security personnel.

30. The apparatus of claim 16, wherein the processor is further configured to perform or control performance of:
identify another augmentation information associated with the target person, wherein the other augmentation information includes one or more of background information, context information, and identification information associated with the target person; and
provide the other augmentation information to the AR device associated with the security personnel when the face of the target person is at least partially visible to the security personnel.

31. A surveillance system for enhanced target tracking through augmented reality (AR) in a surveillance environment, the system comprising:
a plurality of image capture devices configured to monitor the surveillance environment;
a data store configured to store surveillance related data;
an (AR) device associated with a security personnel; and
a server communicatively coupled to the plurality of image capture devices, the data store, and the AR device, wherein the server comprises:
a communication interface configured to facilitate communication between the server and the plurality of image capture devices, the data store, and the AR device;
a processor coupled to the communication interface, wherein the processor is configured to perform or control performance of:
identify a target person to be tracked in the surveillance environment;
determine whether a face of the target person is visible to the security personnel;
responsive to a determination that the face of the target person is at least partially not visible to the security personnel, identify augmentation information associated with the target person; and
provide, through the communication interface, the augmentation information to the AR device associated with the security personnel to be displayed in conjunction with the target person by the AR device.

32. The system of claim 31, wherein the processor is configured to perform or control performance of:
attempt to identify one or more image capture devices capable to capture an image or a video of the face of the target person;
responsive to identification of the one or more image capture devices capable to capture the image or the video of the face of the target person, receive, through the communication interface, the captured image or the captured video of the face of the target person from the identified one or more image capture devices; and
provide, through the communication interface, the captured image or video of the target person as the augmentation information to the AR device.

33. (canceled)

34. The system of claim 31, wherein the processor is configured to perform or control performance of:
attempt to identify one or more image capture devices capable to capture an image or a video of the face of the target person;
responsive to a failure to identify the one or more image capture devices capable to capture the image or the video of the face of the target person, retrieve, through the communication interface, a recent image or a recent video of the face of the target person from the data store: and
provide, through the communication interface, the retrieved recent image or the retrieved recent video of the face of the target person as the augmentation information to the AR device.

35. (canceled)

36. The system of claim 31, wherein the processor is configured to perform or control performance of:
attempt to identify one or more image capture devices capable to capture an image or a video of the face of the target person;
responsive to a failure to identify the one or more image capture devices capable to capture the image or the video of the face of the target person, retrieve, through the communication interface, information associated with the target person from the data store; and
provide, through the communication interface, the retrieved information associated with the target person as the augmentation information to the AR device, wherein the information associated with the target person comprises one or more of a name, an age, a height, a weight, a hair color, an eye color, a facial feature, places visited by the target person over a particular period of time, a job experience, or a criminal record.

37. (canceled)

38. (canceled)

39. The system of claim 31, wherein the processor is configured to perform or control performance of:
provide, through the communication interface, the augmentation information to the AR device associated with the security personnel to be projected onto a back of a head or a torso of the target person by the AR device or to be projected as a label associated with the target person by the AR device.

40. (canceled)

41. The system of claim 31, wherein the processor is configured to perform or control performance of:
determine whether the face of the target person is visible to the security personnel through one or more of:
a determination of whether the security personnel is facing a back of the target person;
a determination of whether lighting conditions allow the security personnel to see the face of the target person clearly;
a determination of whether the face of the target person is covered; and
a determination of whether facial features of the target person are different compared to a recent image of the target person.

42. The system of claim 31, wherein the processor is configured to perform or control performance of:
identify the target person to be tracked in the surveillance environment based on an analysis of one or more images or video received, through the communication interface, from the plurality of image capture devices, or based on information received, through the communication interface, from the security personnel.

43. (canceled)

44. The system of claim 31, wherein the processor is further configured to perform or control performance of:
receive, through the communication interface, a captured image or a captured video of the face of the target person from one or more of the plurality of image capture devices;
analyze the captured image or the captured video of the face of the target person to identify a mood of the target person; and
transmit, through the communication interface, information associated with the identified mood to the AR device associated with the security personnel.

45. The system of claim 31, wherein the AR device includes one of a mobile computer, a wearable computer, or a pair of AR glasses.

46. The system of claim 31, wherein the processor is further configured to perform or control performance of:
identify another augmentation information associated with the target person, wherein the other augmentation information includes one or more of background information, context information, and identification information associated with the target person; and
provide the other augmentation information to the AR device associated with the security personnel when the face of the target person is at least partially visible to the security personnel.
